(19) United States
(12) Patent Application Publication
(10) Pub. No.: US 2011/0176496 A1
(43) Pub. Date: Jul. 21, 2011

(54) ON-THE-FLY VIDEO QUALITY SWITCHING FOR VIDEO DISTRIBUTION NETWORKS AND METHODS THEREFOR

(76) Inventors: Rabinda K. Roy, Milpitas, CA (US); Venkatapathi Rayapati, Cupertino, CA (US)

(21) Appl. No.: 12/688,584

(22) Filed: Jan. 15, 2010

(51) Int. Cl. H04W 72/12; H04N 7/173

(52) U.S. Cl. 370/329; 725/110

(57) ABSTRACT

Methods and systems configured for on-the-fly detection of available wireless bandwidth and for on-the-fly adapting quality of videos to the available wireless bandwidth are disclosed. Techniques are also disclosed to facilitate the transition of video quality to minimize visual artifacts.

### BACKGROUND OF THE INVENTION

The present invention relates to video distribution. More particularly, the present invention relates to techniques for gradually changing the video quality of a displayed video when the available wireless bandwidth for video distribution may fluctuate, over time.

Video distribution refers to the distribution of video content from a video source to an A/V (audio/video) device (for example, a plasma display or a LCD display). In an example prior art video distribution network, a plurality of video sources may be providing video content to a set-top box. The video sources may represent, for example, DVD players, high-definition (HD) players such as Blu-ray players, or other digital and/or analog video sources including, for example, cable/satellite feeds. The set-top box then provides the video signal from one or more of these video sources to a television set or a display device using some physical conduits such as HDMI (High Definition Media Interface) cables or co-axial cables. Since bandwidth tends to be abundant on the physical conduits, high quality video can readily be provided by the video sources (via the set-top boxes) and displayed on the A/V devices.

The wireless interface presents a different challenge. A set-top box may provide the aforementioned video signal to a wireless access point for broadcast over the wireless medium using a suitable protocol such as, for example, any of the 802.11 protocols, LTE, WiMax, CDMA, etc. The wireless access point may represent a different device (such as a modem) or may be integrated with the set-top box.

If the aforementioned AN device has a suitable wireless interface, the video signal provided through the wireless medium can be received by the A/V device and displayed. However, it has been found that for some bandwidth-intensive video applications, such as high definition (HD) video streaming or playback, the wireless medium may from time to time provide insufficient bandwidth to satisfactorily carry the amount of data associated with these bandwidth-intensive video applications. This is because the available wireless bandwidth in a given home or enterprise environment is typically shared among many different wireless devices. At any given time, the amount of bandwidth available to a particular A/V device may fluctuate.

In the case where the bandwidth allocated to the video application is insufficient, the video being displayed on the A/V device may need to be paused while waiting for additional video data to arrive through the wireless medium. In some cases, the video signal may be dropped altogether. For applications such as real time live video streaming, the pausing or cessation of the displayed video is clearly unacceptable. Even for video playback applications, the temporary pausing or cessation of the video playback represents an inconvenience to users.

### BRIEF DESCRIPTION OF THE DRAWINGS

The present invention is illustrated by way of example, and not by way of limitation, in the figures of the accompanying drawings and in which like reference numerals refer to similar elements and in which:.

FIG. 1 shows, in accordance with an embodiment of the invention, a video distribution system for uninterrupted display of a video on one or more displays even when the available wireless bandwidth fluctuates.

FIG. 2 shows, in accordance with an embodiment of the invention, the steps for deciding which video quality would be selected for transmission to the video display device.

FIG. 3 shows, in accordance with an embodiment of the invention, the steps for assessing the quality of the wireless channel.

FIG. 4 shows, in accordance with an embodiment of the invention, a representation of three video streams containing the same video content but in different video quality versions.

FIGS. 5-7 show a series of example transition frames to facilitate discussion of the video quality switching aspect of one or more embodiments of the present invention.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

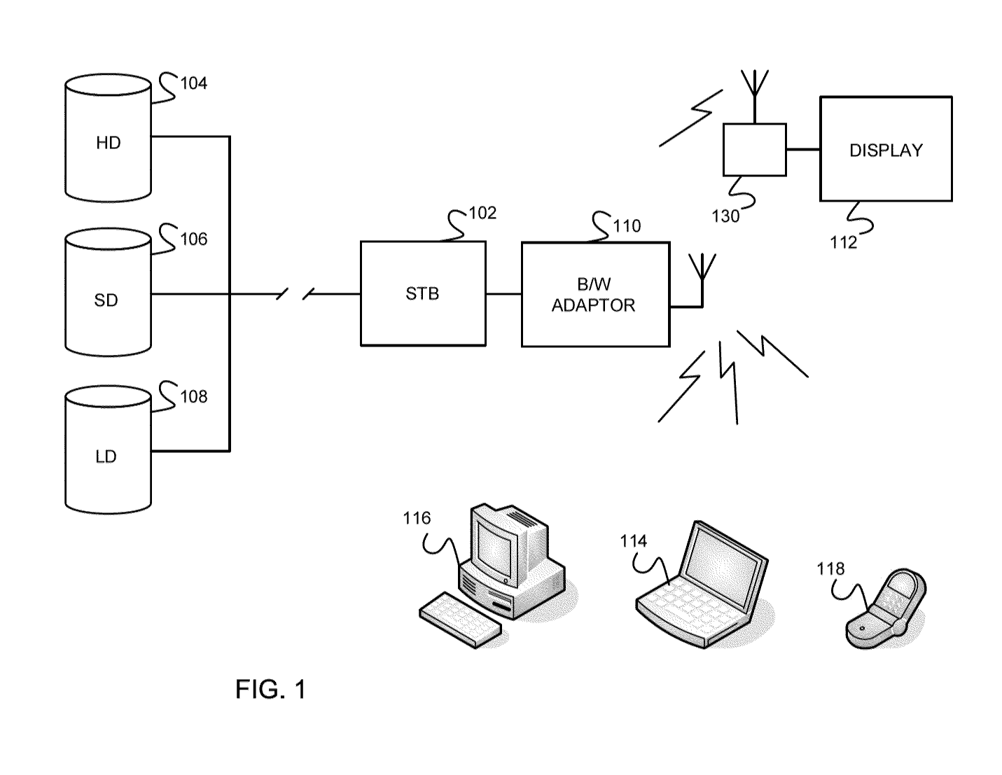

FIG. 1 shows, in accordance with an embodiment of the invention, a video distribution system for uninterrupted display of a video on one or more displays even when the available wireless bandwidth fluctuates. Portions of the video may be displayed with a higher quality version of the video when wireless bandwidth is abundant and a lower quality version of the same video when wireless bandwidth is limited.

With reference to FIG. 1, there is shown a set-top box 102 coupled to receive video input from a plurality of video storage libraries 104, 106, and 108. Although set-top box 102 is shown to facilitate discussion, other devices such as gaming console or other media distribution devices may also be implemented. In the example of FIG. 1, video storage library 104 stores a high definition (HD) version of a given video content (such as a movie); video storage library 106 stores a standard quality (SD) version of the same content; and video storage library 108 stores a lower quality (LD) version of the same content. Other storage devices and/or other media formats may also be implemented if desired.

These three versions have different bandwidth requirements for transmission, with the high definition version requiring the highest amount of bandwidth, the standard quality version requiring a lower amount of bandwidth, and the low quality version requiring the lowest amount of bandwidth for transmission. One skilled in the art will readily appreciate that these libraries may be implemented in one or more physical storage devices as needed. Further, although only three different versions are discussed, it should be recognized that any content may be encoded into any number of different quality versions, each with its own bandwidth requirement for transmission.

Generally speaking, these different quality versions of the same movie may be encoded beforehand (non-real-time) and stored in video storage libraries 104, 106, and 108. Alternatively, encoding may take place on the fly (real-time) from a video source, such as from a high definition video player or from a video recorder, for example. In the example of FIG. 1, the video data from one or more of video storage libraries 104, 106, and 108 are provided to set-top box 102 via co-axial cables although any other suitable transmission medium (such as twisted pairs, fiber optics, etc.) may also be employed.

A video bandwidth adapter 110 is shown coupled between set-top box 102 and the video display devices, such as video display 112, laptop computer 114, desktop computer 116, or smart phone 118. Signal transmission between video bandwidth adapter 110 and set-top-box 102 may be accomplished via a physical medium in an embodiment. In one or more embodiments, signal transmission between video bandwidth adapter 110 and video display 112, laptop computer 114, desktop computer 116, or smart phone 118 may be accomplished using the wireless medium via any one of the suitable protocols for wireless transmission of video data (such as 802.11N 4×4).

Video bandwidth adapter 110 detects the available wireless bandwidth for video transmission, and depending on the available wireless bandwidth and the requirement of the video display device, selects the appropriate video signal from one of video storage libraries 104, 106, or 108 for transmission to the video display device. For example, if video bandwidth adapter 110 ascertains that a large amount of wireless bandwidth is available, video bandwidth adapter 110 may select the high definition video signal from video storage library 104 to be delivered to video display 112. At some other time, if video bandwidth adapter 110 ascertains that a low amount of wireless bandwidth is available, video bandwidth adapter 110 may select a lower quality video signal from, for example, video storage library 106 or 108 to be delivered to video display 112. Video bandwidth adapter 110 may perform a similar function for videos transmitted for display on laptop computer 114, desktop computer 116, or smart phone 118.

FIG. 1 shows a display adapter 130, representing an optional adapter for enabling legacy video displays to communicate with video bandwidth adapter 110. Some legacy video displays and other video display devices may natively communicate using a different interface or protocol than that employed by video bandwidth adapter 110. Display adapter 130 provides a communication bridge and some buffering functionality between such a legacy video display device and video bandwidth adapter 110. It should be noted that if a video display device is compatible with video bandwidth adapter 110, a display adapter is not required.

In one or more embodiments, laptop computer 114, desktop computer 116, or smart phone 118 may be provisioned with software and/or software driver for communicating with video bandwidth adapter 110 via the wireless medium. In this manner, laptop computer 114, desktop computer 116, or smart phone 118 may display the video with the appropriate quality that may be transmitted as the available wireless bandwidth fluctuates.

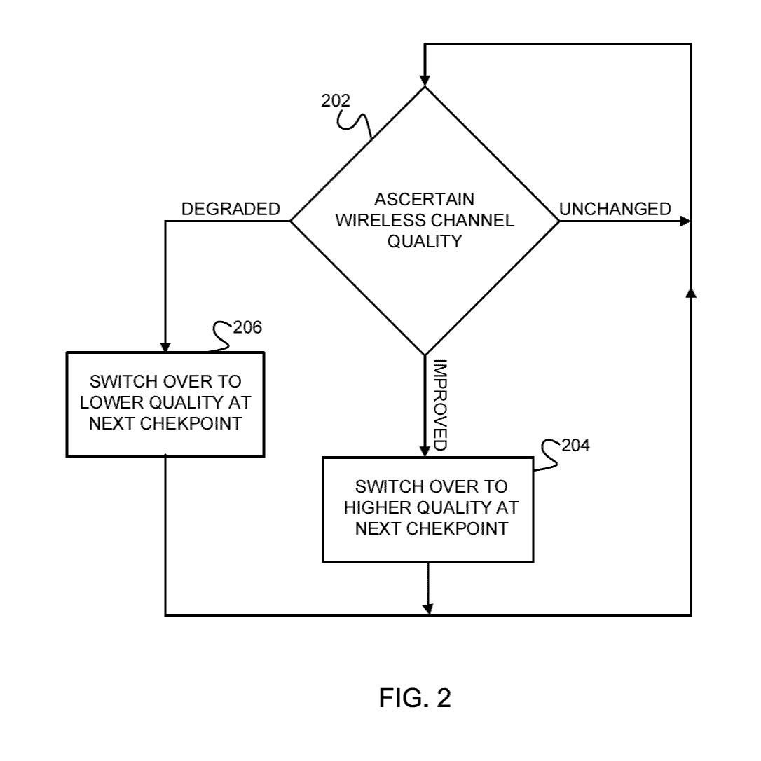

FIG. 2 shows, in an embodiment of the invention, the steps for deciding which video quality would be selected for transmission to the video display device. Generally speaking, the steps of FIG. 2 are performed by logic circuitry in video bandwidth adapter 110 although such steps may also be delegated to another device if desired. Generally speaking, the video content may be conceptually or physically divided into a plurality of segments, with each pair of adjacent segments separated by a checkpoint. The video transmission may begin with a given segment using a default quality such as, for example a standard quality. However, any quality version may be set as the default quality if desired. In step 202, the quality of the wireless channel is ascertained. If the quality of the wireless channel is unchanged, the method returns to step 202 to continue to monitor the quality of the wireless channel. Meanwhile, video transmission continues with the existing quality mode.

However, if the quality of the wireless channel improves (step 204), the next segment would be transmitted in a better quality mode (e.g., standard quality to high definition quality) for display on the AN device. Of course if the video transmission mode is already in the highest quality mode, the next segment will continue to be transmitted in the highest quality mode. Thereafter, the method returns to step 202 to continue to monitor the quality of the wireless channel.

On the other hand, if the quality of the wireless channel degrades (step 206), the next segment would be transmitted in a lower quality mode (e.g., standard quality to lower quality). Of course if the video transmission mode is already in the lowest quality mode, the next segment will continue to be transmitted in the lowest quality mode if possible. Thereafter, the method returns to step 202 to continue to monitor the quality of the wireless channel.

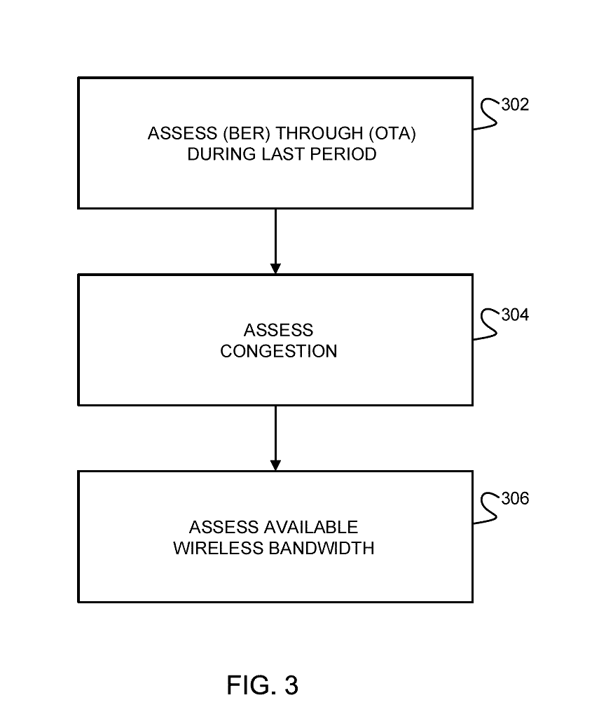

FIG. 3 shows, in accordance with an embodiment of the invention, the steps for assessing the quality of the wireless channel. In step 302, the bit error rate (BER) in the last time period may be assessed through the over-the-air (OTA) interface. BER measurement through OTA is only one method of assessing wireless channel quality and other methods are possible, as can be appreciated by those skilled in the art. In this example, the last time period may be the last few milliseconds or during the last few video frames of a segment, for example. In step 304, the congestion of the wireless channel is assessed based on, for example, the number of users and the channel activity. Channel activity may depend on the number and types of applications currently placing demand on wireless bandwidth, for example. Other parameters may also be employed to ascertain the congestion of the channel if desired. In step 306, the wireless bandwidth available for video transmission is ascertained in view of the congestion determined in step 304. This available wireless bandwidth may be compared to the available wireless bandwidth in the past to determine whether the wireless channel quality has stayed the same, has improved, or has degraded.

In an embodiment, a relative figure of merit may be predefined and if parameters reflective of wireless channel congestion and bit error rate falls below this figure of merit for more than some predefined duration, the quality of the wireless channel may be deemed to have degraded to the point where standard video transmission is not possible and a lower quality video transmission mode is needed. For example, a KPI (Key Performance Indicator) may be predefined as a function of one or more of the video performance metrics (e.g., jitter, delay, channel quality, interference, etc.). Alternatively, if parameters reflective of wireless channel congestion and bit error rate exceeds this figure of merit for more than some predefined duration, the quality of the wireless channel may be deemed to have improved to the point where high definition video transmission is possible.

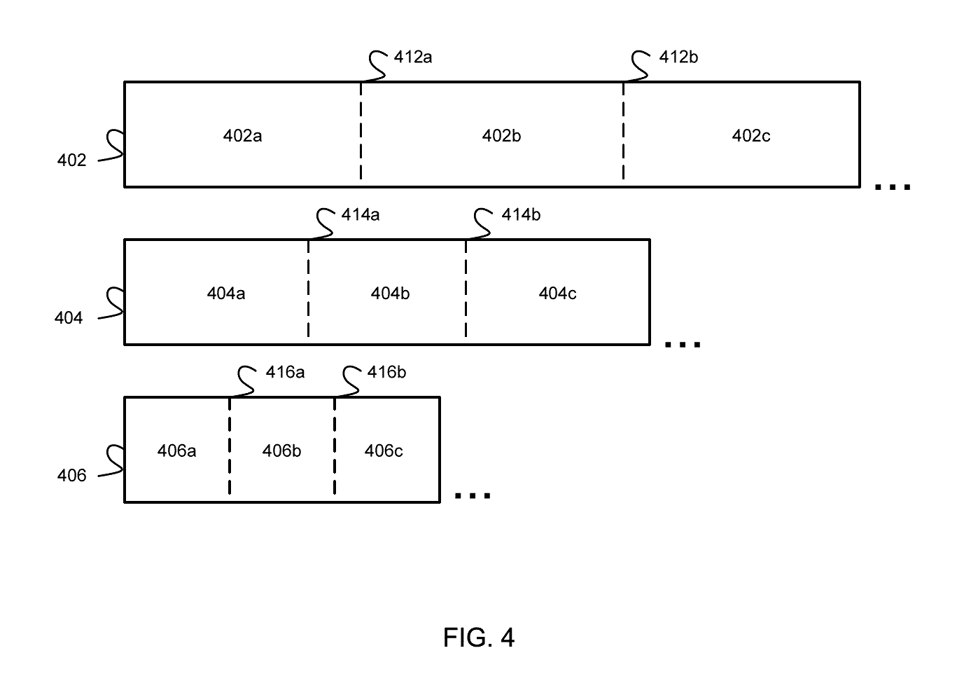

FIG. 4 shows, in accordance with an embodiment of the invention, a representation of three video streams 402, 404, and 406 containing the same video content but in different quality versions. Video streams 402, 404, and 406 may represent files stored on one or more storage devices (e.g., hard drives or other non-volatile memory storage devices) or may be generated on-the-fly from a single video source (e.g., high definition video player or video recorder) as necessary. As can be seen, high definition video 402 requires more data to carry the high definition video than standard quality video 404, which in turn requires more data to carry the video content than lower quality video 406.

Video streams 402, 404, and 406 are divided into segments at the same location in the stream, e.g., between the same adjacent video frames in the same embodiment in all three video streams. Video segments 402a, 402b, and 402c of high definition video stream 402 are delineated by breaks 412a and 412b. Video segments 404a, 404b, and 404c of standard quality video stream 404 are delineated by breaks 414a and 414b. Video segments 406a, 406b, and 406c of lower quality video stream 406 are delineated by breaks 416a and 416b. Depending on the available wireless bandwidth, the video stream may be displayed using a high definition segment 402a, to be followed by a standard definition segment 404b, to be followed by a low quality segment 404c. In this manner, although the video segment sequence (e.g., a-b-c) is still employed, the actual video displayed may comprise segments from different quality versions.

As can be appreciated from the foregoing, embodiments of the invention allow the video stream to continue to be displayed even if the available wireless bandwidth falls below the threshold possible to display a higher quality video. In contrast to the prior art wherein such deficient wireless bandwidth situation would have caused a cessation of video display until video transmission catches up, embodiments of the invention allows the video display to continue albeit with a lower quality. With proper buffering and smoothing at the display device, it is possible to display the video using segments from different video quality versions while minimizing the visual breaks or other visual artifacts perceptible to the human user.

As mentioned, smoothing may also be employed to minimize the visual breaks or visual artifacts perceptible to the human user. In one or more embodiments of the invention, post processing of the video data may permit a gradual, on-the-fly transition of video quality (e.g., from SD to HD or vice versa) when the video quality is changed responsive to available wireless bandwidth.

To elaborate, raw video (e.g., from a video camera or any other source) is typically source-encoded to, for example, reduce redundancy and to conform to a standard for transmission and viewing. Some of these standards may be, for example MPEG or DiVX. The source-encoded video may then be channel-encoded for transmission purposes (e.g., into one or more of the OTA interfaces or other interfaces to be transmitted over other media). After being transmitted, the reverse process takes place where the received video data stream is channel-decoded and source-decoded to reconstruct the original raw video. Post processing is then performed after source-decoding in order to permit the video to be displayed on a particular display device. For example, post processing may include setting the dynamic range, the color saturation, the aspect ratio, the intensity, etc., for display on a particular display device.

During the transition period when a video stream switches from one video quality to a different video quality to dynamically respond to the available wireless bandwidth, a number of frames may be involved during the transition. For discussion purposes, these frames are referred to herein as “transition frames” to denote that they are displayed during the transition period where the video quality switches from one video quality to a different video quality. The transition period (which determines number of transition frames) may vary according to the specifics of the video application and the video display. Generally speaking, the transition period may last from tens of milliseconds to one second.

In one or more embodiments, each frame of the transition frames may be interlaced with video data from both the transition-from video quality and the transition-to video quality. For example, if the transition is from a low video quality to a standard video quality, a frame in the transition frames may be interlaced with video data from both the low video quality (transition-from video quality) and the high video quality (transition-to video quality). The interlacing is performed on a row-by-row basis, with rows of video data from the transition-to video stream replacing the rows of video data from the transition-from video stream.

For example, transition frame N may have 100% of its rows filled with low quality video and transition frame N+1 may have 90% of its rows filled with low quality video and 10% filled with standard quality video while transition frame N+2 may have 80% of its rows filled with low quality video and 20% filled with standard quality video and so on (with transition frame N+M representing the last of the transition frames and filled with 100% of standard video quality rows). This approach to transition by replacing rows is referred to herein as the row replacement approach.

In one or more embodiments, the replacement may be performed for odd rows first until all odd rows are replaced, and the replacement may then proceed with even rows until all rows are replaced. Alternatively, in one or more embodiments, the replacement may be performed for even rows first until all even rows are replaced, and the replacement may then proceed with odd rows until all rows are replaced. The number of rows to be replaced from frame-to-frame may vary depending on desired smoothing effect, the video application involved, and the video display involved. Generally speaking, it is desired to keep the transition period as short as possible in order to minimize the overhead associated with transitioning (which includes receiving and processing both the “transition-from” video frames and the “transition-to” video frames in order to display both in an interlaced manner). The exact transition period maybe empirically determined and predefined in advance or may be user-selectable, if desired.

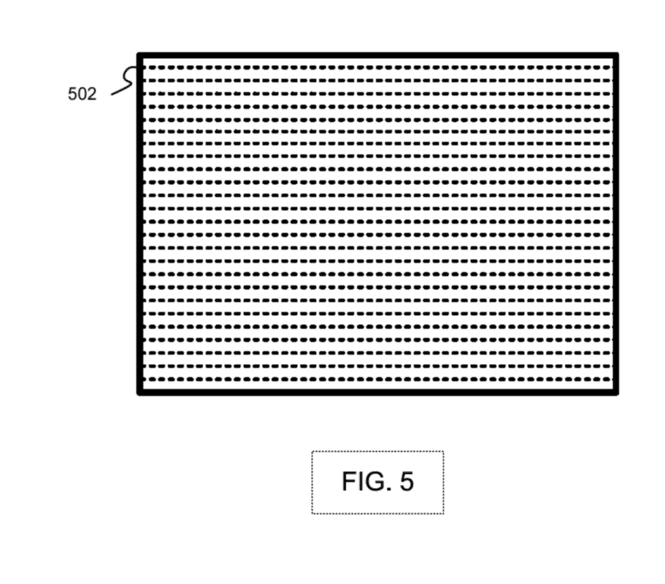

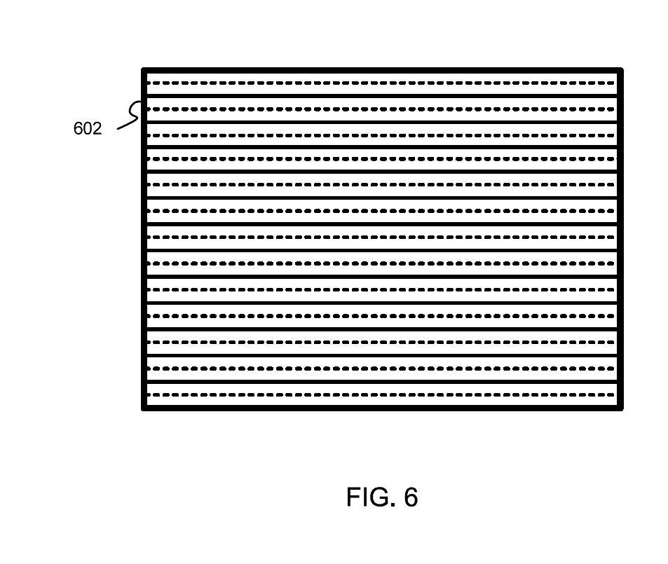

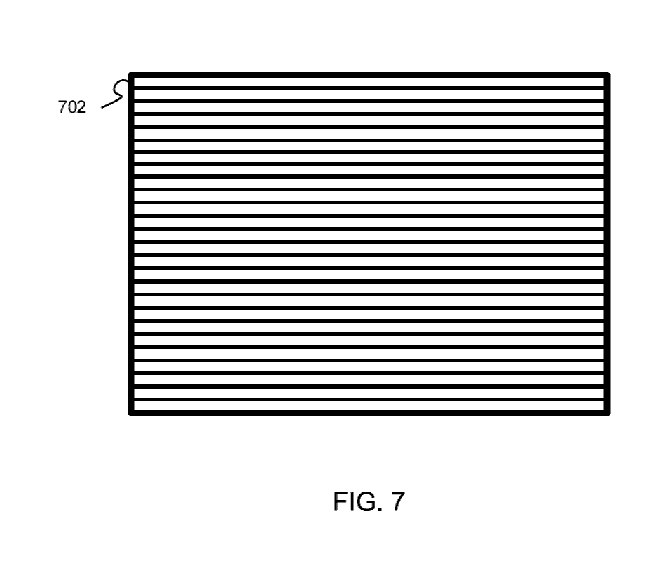

FIG. 5 shows, in accordance with an embodiment of the invention, a transition frame 502 with all of its rows occupied by low video quality (the transition-from video quality in this example) data. FIG. 6 shows, in accordance with an embodiment of the invention, a transition frame 602 with some of its rows occupied by low video quality data and some of its rows occupied by standard video quality data (the transition-to video quality in this example) as the transition progresses. FIG. 7 shows, in accordance with an embodiment of the invention, a transition frame 702 with all of its rows occupied by standard video quality data as the transition completes. After the transition completes, video display may continue with the standard-quality video data.

As can be appreciated from the foregoing, embodiments of the invention allow the video quality to switch mid-stream from one video quality to another video quality while minimizing distracting visual artifacts. The on-the-fly switching of video quality is highly advantageous when coupled with the ability to dynamically detect available wireless bandwidth and to on-the-fly adapt the video quality to the available wireless bandwidth. In this manner, video display may continue uninterrupted and in a substantially transparent manner to the viewer even when the available wireless bandwidth fluctuates.

While this invention has been described in terms of several embodiments, there are alterations, permutations, and equivalents, which fall within the scope of this invention. It should also be noted that there are many alternative ways of implementing the methods and apparatuses of the present invention. It is therefore intended that the description be interpreted as including all such alterations, permutations, and equivalents as fall within the true spirit and scope of the present invention.

What is claimed is:

1. A video bandwidth adapter configured for receiving a plurality of video signals representing different quality versions of a video content and providing at least one of said different quality versions to a video display, comprising:
circuitry for ascertaining available wireless bandwidth while a given one of said plurality of video signals is transmitted to said video display;
circuitry for selecting a bandwidth-appropriate one of said plurality of video signals, said bandwidth-appropriate one of said plurality of video signals being associated with a quality version of said video content that is suitable for transmission to said video display given said available wireless bandwidth; and
circuitry for transmitting, after a transition period, said bandwidth-appropriate one of said plurality of video signals from said video bandwidth adapter to said video display instead of said given one of said plurality of video signals, said bandwidth-appropriate one of said plurality of video signals and said given one of said plurality of video signals representing two different quality versions of said video content, wherein data from both said bandwidth-appropriate one of said plurality of video signals and said given one of said plurality of video signals are both displayed in a transition frame during said transition period, said transition period representing a time duration for switching video quality on said video display.

2. The video bandwidth adapter of claim 1 wherein said different quality versions of said video content are stored in a plurality of video storage libraries.

3. The video bandwidth adapter of claim 2 wherein said different quality versions of said video content are encoded in a non-real-time manner and stored in advance in said plurality of video storage libraries.

4. The video bandwidth adapter of claim 2 wherein said different quality versions of said video content are encoded in a real-time manner and stored in advance in said plurality of video storage libraries.

5. The video bandwidth adapter of claim 1 wherein said plurality of video signals are provided from a set-top box.

6. The video bandwidth adapter of claim 1 wherein said bandwidth-appropriate one of said plurality of video signals is provided to a display adapter configured to enable said video display to communicate with said video bandwidth adapter.

7. A computer-implemented method for ascertaining a quality version of a video to select for transmission to one or more video displays, said video being encoded into a plurality of quality versions, each of said plurality of quality versions being divided into a plurality of segments with adjacent segments separated by a checkpoint, comprising:
ascertaining quality of a wireless channel while said video is transmitted to said one or more video displays utilizing a given one of said plurality of quality versions;
if said quality of said wireless channel is unchanged, continue monitoring said quality of said wireless channel;
if said quality of said wireless channel improves, transmitting to said one or more video displays a next segment associated with a higher quality version of said video, wherein data associated with both said higher quality version said video and said given one of said plurality of quality versions are both displayed in a transition frame during a first transition period, said first transition period representing a time duration for switching video quality from said given one of said plurality of quality versions to said higher quality version on video display; and
if said quality of said wireless channel degrades, transmitting to said one or more video displays said next segment associated with a lower quality version said video, wherein data associated with both said lower quality version said video and said given one of said plurality of quality versions are both displayed in a transition frame during a second transition period, said second transition period representing a time duration for switching video quality from said given one of said plurality of quality versions to said lower quality version from said on said video display.

8. The computer-implemented method of claim 7 wherein given one of said plurality of quality versions represents a default video quality version.

9. The computer-implemented method of claim 7 further comprising, if said quality of said wireless channel is unchanged, continuing said transmission using said given one of said plurality of quality versions.

10. The computer-implemented method of claim 7 further comprising, if said given one of said plurality of quality versions already represents a highest quality version before said quality of said wireless channel is ascertained to have improved, continuing to transmit said next segment in said highest quality version.

11. The computer-implemented method of claim 7 further comprising, if said given one of said plurality of quality versions already represents a lowest quality version before said quality of said wireless channel is ascertained to have degraded, continuing to transmit said next segment in said lowest quality version.

12. The computer-implemented method of claim 7 wherein said ascertaining said quality of said wireless channel is performed by measuring a bit error rate (BER).

13. The computer-implemented method of claim 12 wherein bit error rate (BER) is obtained for a last time period through an over-the-air (OTA) interface.

14. The computer-implemented method of claim 7 wherein said switching video quality is performed using a row replacement approach.

15. An article of manufacture comprising a program storage medium having computer readable code embodied therein, said computer readable code being configured for ascertaining a quality version of a video to select for transmission to one or more video displays, said video being encoded into a plurality of quality versions, each of said plurality of quality versions being divided into a plurality of segments with adjacent segments separated by a checkpoint, comprising:
computer readable code for ascertaining quality of a wireless channel while said video is transmitted to said one or more video displays utilizing a given one of said plurality of quality versions;
if said quality of said wireless channel is unchanged, computer readable code to continue monitoring said quality of said wireless channel;
if said quality of said wireless channel improves, computer readable code for transmitting to said one or more video displays a next segment associated with a higher quality version of said video, wherein data associated with both said higher quality version said video and said given one of said plurality of quality versions are both displayed in a transition frame during a first transition period, said first transition period representing a time duration for switching video quality from said given one of said plurality of quality versions to said higher quality version on video display; and
if said quality of said wireless channel degrades, computer readable code for transmitting to said one or more video displays said next segment associated with a lower quality version said video, wherein data associated with both said lower quality version said video and said given one of said plurality of quality versions are both displayed in a transition frame during a second transition period, said second transition period representing a time duration for switching video quality from said given one of said plurality of quality versions to said lower quality version from said on said video display.

16. The article of manufacture of claim 15 wherein given one of said plurality of quality versions represents a default video quality version.

17. The article of manufacture of claim 15 further comprising, if said quality of said wireless channel is unchanged, computer readable code for continuing said transmission using said given one of said plurality of quality versions.

18. The article of manufacture of claim 15 further comprising, if said given one of said plurality of quality versions already represents a highest quality version before said quality of said wireless channel is ascertained to have improved, computer readable code for continuing to transmit said next segment in said highest quality version.

19. The article of manufacture of claim 15 further comprising, if said given one of said plurality of quality versions already represents a lowest quality version before said quality of said wireless channel is ascertained to have degraded, computer readable code for continuing to transmit said next segment in said lowest quality version.

20. The article of manufacture of claim 15 wherein said ascertaining said quality of said wireless channel is performed by measuring a bit error rate (BER).
